(19) United States
(12) Patent Application Publication
(10) Pub. No.: US 2002/0182000 A1
(43) Pub. Date: Dec. 5, 2002

(54) Spring loaded pin connector for securing a child vehicle seat to an anchorage

(76) Inventors: William Ward, Jr., Uniontown, OH (US); Robert C. Barrett, Angola, NY (US)

Correspondence Address: Stephen A. Bent, FOLEY & LARDNER, Washington Harbour, 3000 K Street, N.W., Suite 500, Washington, DC, 20007-5109, US

(21) Appl. No.: 09/870,709

(22) Filed: Jun. 1, 2001

(51) Int. Cl. F16D 1/00; B25G 3/18; F16B 21/00

(52) U.S. Cl. 403/325

(57) ABSTRACT

The present invention relates to a connector for coupling tether straps attached to child vehicle seats to anchorages provided on the vehicle, e.g., anchorages provided on the package shelf of the vehicle or anchorages located at the crease of the seat bottom and seat back. The latch provides advantages over the common “J” hook currently in use, including an actuator remote from a spring-loaded pin used to block the entrance to an anchorage receiving area. In addition, the connector may include an opening for attachment of a tether strap. In a preferred embodiment, the latch further includes a plate which is coupled to a strap length adjuster, the plate and adjuster being pivotally connected to permit side-to-side rotation of the adjuster relative to the latch to prevent bunching or twisting of the strap which can cause the belt to lose its ability to uniformly distribute a load across its width. Furthermore, the adjuster itself may be coupled to a plate which is pivotably coupled to the plate attached to the connector, to thereby permit movement of the strap about two perpendicular axes.

### BACKGROUND OF THE INVENTION

1. Field of the Invention

The present invention relates generally to the art of systems for securing children's vehicle seats to vehicles, and more particularly to connectors for securely attaching one end of a strap to an anchorage located on the vehicle. Still more specifically, and in a preferred embodiment, the invention relates to a connector having a spring loaded pin and an operator for the pin which is remote from a receiving area of the connector. The connector is coupled directly to a tether strap in one embodiment. In another embodiment of the invention, a plate with an opening and a pivot assembly are attached to the connector to prevent bunching or twisting of the strap, and in a still further embodiment, a belt length adjuster with a pivot is attached to the plate to allow the strap to pivot in two perpendicular axes about an end of the connector.

2. Description of the Prior Art

It has been known for many years that infant, toddler or children vehicle seats (herein generally referred to as “child vehicle seats”) can be secured to a vehicle using the restraint belts provided with the vehicle, e.g. shoulder and/or lap belts, and that additional top tether straps may be employed. For example, U.S. Pat. No. 5,265,931 issued Nov. 30, 1993 to Ryan for “Detachable Child Seat And Supporting Frame” shows a top tether strap 48 having a “J” hook on its end to assist in securing a child vehicle seat. In this particular patent, the tether strap is secured to a shelf (commonly called a “package shelf”) behind the rear seat.

Another tether strap system is disclosed in U.S. Pat. No. 5,695,243 issued Dec. 9, 1997 to Anthony et al. for “Child Seat Mount With Anti-Twist Web Mechanism”, in which a tether strap is used when the seat is either in a forward or rearward facing orientation. This tether strap is also coupled to the package shelf using a buckle similar to a conventional seat belt buckle.

Additional tether restraints are shown in U.S. Pat. No. 5,630,645 issued May 20, 1997 to Lumley, et al. for “Safety Seat Tether Strap” and in United Kingdom Patent Specification No. 1,374,266 dated Jan. 7, 1963, entitled “Improvements In And Relating To Children's Safety Seats For Use In Vehicles And Craft”. In the latter, two straps are employed for releasably coupling the seat to two spaced apart anchorages located on the vehicle.

Recent regulations promulgated in the United States have required vehicle manufacturers to place anchorages in their products, so that child vehicle seats can be more securely coupled to the vehicles. Regulations in effect since 1999 resulted in the addition of an anchorage for the top part of the seat, to reduce head excursion. By Sep. 1, 2002, child vehicle seat manufacturers will be required to include components on the child vehicle seat to secure it to a pair of lower anchorages, which will consist of round metal bars spaced 280 mm, center-to-center, and which will be located in the rear seats at the crease where the seat back and the seat cushion come together. Many car seat manufacturers will accomplish this by adding tether straps to the lower portion of their products, so that the tether straps can be coupled to the round metal bars in the vehicle. The development of strong and easy to use latches or connectors for these various tether strap anchorages is important, and, in the case of the lower anchorages, the attachment of conventional “J” hooks will be difficult because of the placement of the anchorages relative to the seat components.

One suggested solution is described in commonly owned U.S. patent Ser. No. 09/564,952, filed May 4, 2000 and entitled “Tether Latch for Securing a Child Car Seat to an Anchorage”, incorporated by reference herein. This application also describes the use of single and double pivot axis attachment of the straps to the latches or connectors to prevent bunching or twisting of the straps which could result in a loss of strength of the straps. Improvements in connector systems for use in these environments, particularly ones in which coupling and uncoupling is facilitated, will represent significant advances in this art.

### SUMMARY OF THE INVENTION

The present invention relates to a connector that includes a spring-loaded pin mechanism for selectively permitting a receiving area of the connector to be placed about or removed from an anchorage. In a preferred embodiment, operation of the connector is carried out by pushing the anchorage against the pin to cause the pin to retract under spring pressure. When the anchorage enters the connector by a sufficient distance, it will move into a receiving area, and the pin will snap forwardly to securely hold the anchorage in its coupled position. To remove the connector, the pin is pulled inwardly, preferably by a sliding button or finger hook, and, when the anchorage is freed to escape the front of the connector, the connector is simply pulled away from the anchorage. The connector may include a plate which is pivotally coupled to a strap length adjuster. In its most preferred form, the connector is pivotally coupled to a plate which in turn is pivotally coupled to a strap length adjuster, thereby permitting movement of the strap with respect to the connector in two planes which are perpendicular to one another, to thereby prevent bunching or twisting of the strap. Other ways in which individual features or combinations of the above-mentioned features, or still further features of the invention, are accomplished will become apparent to those skilled in the art after they have read the present specification. Accordingly, the present invention is not deemed to be limited to the embodiments described below, but it is to be limited solely by the scope of the claims which follow.

### DETAILED DESCRIPTION OF THE DRAWINGS

In the following FIGURES like reference numerals are used to indicate like components, and

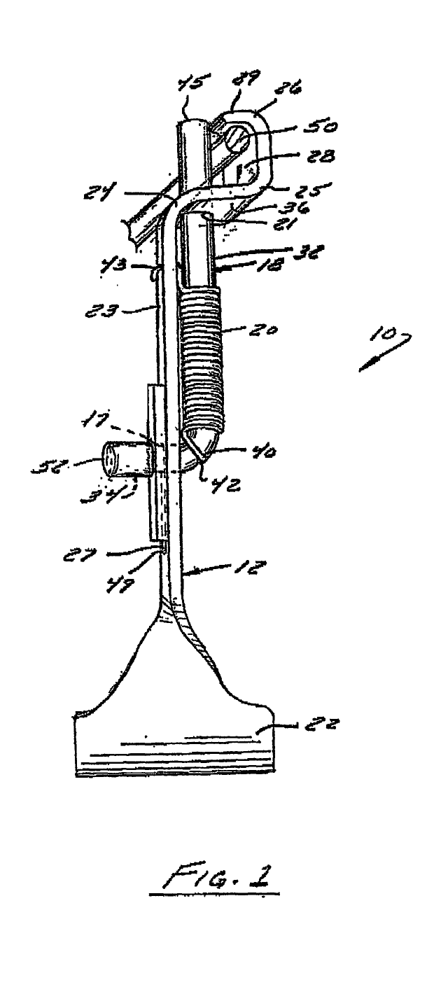

FIG. 1 is a side view of interior connector components according to one preferred form of the invention;

FIG. 2 is a side view of the connector shown in FIG. 1 encased in an outer housing and rotatably coupled to a strap length adjuster;

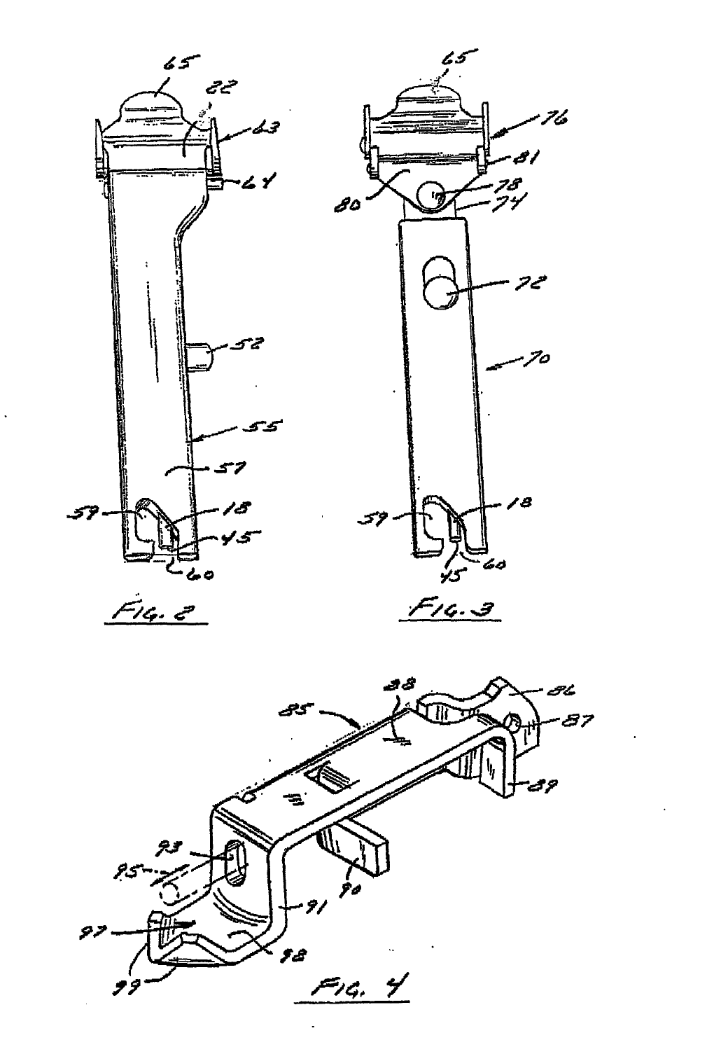

FIG. 3 is a side view of a modified connector as shown in FIG. 1, with the actuator button moved to side and the connector being coupled to a strap length adjuster which can pivot in two perpendicular planes;

FIG. 4 is a perspective view of an alternate embodiment of the interior stamping of a connector according to the present invention and including bent corner tabs on the stamping;

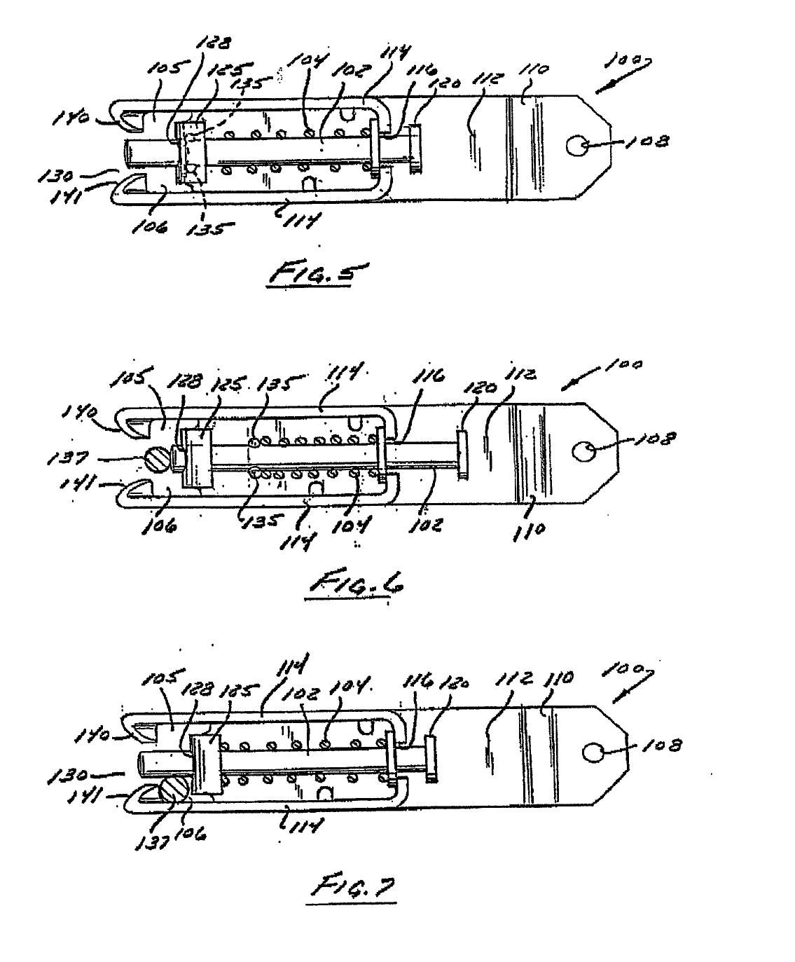

FIGS. 5-7 are schematic views of a connector according to a preferred embodiment of the invention (with outer housing components removed) and illustrating pin retraction and the ability of the anchorage to seat on either side of the pin;

FIG. 8 is a perspective view of the stamping of the connector shown in FIGS. 5-7;

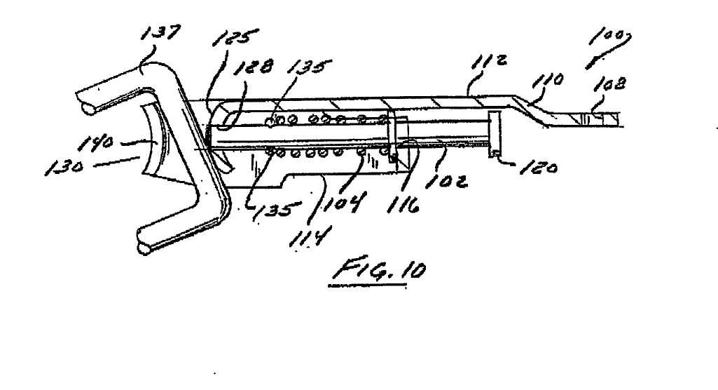

FIG. 9 is a perspective view of the stamping of the connector shown in FIGS. 5-7; and

FIG. 10 is a side sectional view of the connector shown in FIGS. 5-7 and illustrating anchorage alignment.

### DETAILED DESCRIPTION

Before proceeding to the description of the preferred and alternate embodiments of the present invention, several general comments can be made about the applicability and the scope of the present invention. First, while several preferred connectors are shown, and at least two alternate alignment systems are illustrated in the present application, the connectors may be used without the alignment systems, and the alignment systems may be used with connectors other than the ones shown in the drawings.

Second, the FIGURES provided with this specification show at least two different types of strap length adjusters, but the type of adjuster, in and of itself, does not form part of the present invention, and the adjuster type may be selected from any of those known in the art. Adjusters used in cars, trucks, airplanes and numerous other environments (e.g. backpacks, camping, etc.), in which the length of a belt or strap is adjusted for safety, convenience or the like, may be used with the present invention.

Third, the way in which the tether straps are attached to the child vehicle seat can also be variously embodied and does not, in and of itself, form part of the present invention. By way of example, but not by way of limitation, the child vehicle seat can have anchorage bars similar to those used in the vehicle, and a connector such as those illustrated, may be used to attach each end of the tether strap respectively to the vehicle anchorage and to the seat anchorage. Alternately, the strap could be attached to the seat using fasteners, adhesives, and the like. With regard to the lower anchorages, either a single strap with a connector at each end and passing through the child vehicle seat may be employed, or a pair of straps may be used which are separately anchored to the child vehicle seat.

Fourth, the particular shape of the connector shown in the FIGURES is not critical nor is the particular distance between the receiving area and the connector pin actuator. It is advantageous, however, to have that distance exceed about 70 millimeters, so that the connector may be easily operated, even when the anchorage is located within the crease of the rear vehicle seat.

Fifth, the particular materials employed for manufacture of the latch are dictated primarily by strength requirements, but such components as the cover for the latch may be made out of lightweight materials such as plastics, sheet metal stampings and the like.

Sixth, the term “vehicle” as used herein is meant to include vehicles where infant, toddler or child seats are used, e.g. automobiles, sport utility vehicles, vans, trucks, planes, buses, trains, boats and the like.

Proceeding now to a description of the preferred embodiments of the invention, FIG. 1 is a side view of the interior components of one preferred connector 10. Connector 10 includes four major components: a metal stamping 12, a cover 14 (not shown in the FIGURE), a pin 18 and a spring 20.

FIG. 1 is intended to show in its most basic form connector 10 and how it functions to attach a strap to an anchorage. First, it will be noted that the metal stamping 12 is curled at a first end 22 and twisted 900 at the area designated 22. The stamping 12 then continues along area 23 to a point where a series of three 90° bends, 24, 25 and 26 create a generally U-shaped receiving area 28. The second end 29 of stamping 12 lies in a plane which is below the plane of area 23 for reasons which will soon become apparent.

An L-shaped pin 18 includes a long leg 32 and a short leg 34. Short leg 34 extends through area 23 and is movable along a slot 27 in area 23 for reciprocal movement toward and away from end 29, while leg 32 extends beneath area 23 and penetrates wall 36 of stamping 12 between bends 24 and 25. A hole 21 is provided therein having a diameter slightly exceeding that of pin 18.

The spring 20 is an extension spring and surrounds leg 32 of pin 18. One end 40 of the spring 20 is coupled to pin 18 at 42, while the other end 43 of the spring 20 is secured to the side of area 23. The various components are arranged so that the following occurs. First, the dimensions of the pin 18 and the slot 27 are selected so that the outer tip 45 of pin 18 is located over the end 29 of stamping 12 when the leg 34 resides at the top end 47 of the slot 27. Second, the spring 20 is arranged to extend if the pin 18 is urged toward the first end 22 of stamping 12, the leg 34 moving along the slot 27 toward its second end 49. When the leg 34 contacts the second end 49 of the slot, the tip 45 of pin 18 will be located near the wall 36 but still penetrate the hole 21. Functionally, this movement will result in the receiving area 28 being entirely open.

For purposes of providing a general understanding of the present invention, the operation of connector 10 will now be described in connection with FIG. 1. However, the reader should understand at this point that a covering (described later), as well as lead-in ramps in the preferred embodiment, will surround, encase and/or protect the functional “guts” of the connector 10 shown in FIG. 1. It should also be appreciated that all connectors of this invention rely on a spring-loaded pin (such as pin 18) which will be pushed against an anchorage bar causing the pin to move away from the outer end of the particular connector. When the pin is retracted to a point, at least by an amount greater than the diameter of the anchorage bar, the bar will drop into the receiving area, thereby causing the pin to snap back to its original position which will prevent uncoupling of the connector and the anchorage.

When it is desired to remove the connector from the anchorage, the pin is movably retracted by the user, in this case by pulling the leg 34 of pin 18 along the slot to its end 49, tilting the connector slightly to remove the rod 50 (shown in FIG. 1) from the receiving area 28. The pin is then allowed to move forwardly under spring pressure, e.g., it is released, thereby closing the receiving area 28 and allowing removal of the connector 10, as well as the attached strap. The fact that the actuator for the spring-loaded pin 18 (i.e., the short leg 34 in this case covered with a protective plastic sleeve 52) is located remotely from the anchorage capture receiving area 28 allows the connector 10 to be used in relatively confined areas such as the crease between a seat back and a seat, the location chosen by regulators for the placement of anchorage bars pursuant to the aforementioned 2002 standards. Separation of the actuator from the receiving area by at least 70 mm is preferred, but about 10 mm to more than 70 mm is also within the scope of the invention. Naturally the spring force should be selected to permit convenient use by male or female owners of vehicle seat products, while being strong enough to prevent inadvertent escape of the anchorage bar 50 from the receiving area 28.

FIG. 2 illustrates several additional features of the present invention using the connector 10 shown in FIG. 1. In this version, the connector 55 includes an outer case 57 made, for example, from molded plastic or a lightweight metal stamping and having an open mouth 59 and a slot 60, through which the anchorage bar 50 is urged against end 45 of pin 18. The entrance to slot 60 should be rounded or slanted as shown to facilitate proper alignment of the connector 55 and rod 50. The receiving area is also prominently shown in this drawing.

At its opposite end, connector 55 is shown rotatably coupled to a strap length adjuster 63 by a pin 64 passing through the curled area 22 of metal stamping 12. As previously mentioned, the adjuster may be of any known design, the one illustrated having a tab 65 which is lifted to allow the length of the strap to be changed. The rotation allowed about the axis of pin 64 will help align the strap and connector 55, preventing bunching and twisting and the resultant problems of wear and loss of strength.

A slight modification for a connector 70 is shown in FIG. 3, where the actuator 72 for the pin 18 is shown rotated 90° with respect to the long axis of the connector 70. In addition, a small plate 74 is affixed to the end of the connector 70 remote from its mouth. Plate 74 serves as a pivotal mounting for an adjuster 76, by the use of a rivet 78. The adjuster 76, includes a curled plate 80 which is rotatably mounted to plate 74 for rotation about a first axis defined by the rivet 78, and a pin 81 secures the balance of the adjuster 76 to plate 80 for pivotal movement about a second axis (defined by the axis of pin 81) that is perpendicular to the first axis. The balance of the adjuster 76 is the same as that shown in FIG. 2. The double pivot concept further prevents bunching or twisting, when compared to the embodiment shown in FIG. 2. The use of single and double pivot couplings for adjusters and connectors is disclosed in the aforementioned commonly-owned U.S. patent Ser. No. 09/564,952, filed May 4, 2000, but it is very well suited for the different types of connectors disclosed herein, i.e., connectors which function on the principle of pushing the connector directly onto an anchorage bar.

Not shown in the drawings, but equally applicable to the present invention would be the provision of a simple slot in the end of metal stamping 12 shown in FIG. 1 to be curled. The strap length adjuster would then be affixed to the stamping 12 at the slot. In such an embodiment, the adjuster would not self-align, but pivot components are eliminated and, hence, manufacturing time and cost could be reduced.

FIG. 4 is a perspective view of an alternate stamping 85 having a plate end 86 having a hole 87 for attachment of a rivet for a strap length adjuster (not shown). The middle portion 88 of stamping 85 includes three downwardly depending bends 89, 90 and 91. The actuator (if shown) would be located between bends 89 and 90, and the spring would be located between bends 90 and 91. The pin (not shown) would penetrate the hole 93 in bend 91 and a hole (not shown) in bend 90, and the tip of the pin would move generally along the dotted line path illustrated at 95. Below such path 95, a receiving area 97 is defined by the path 95, bottom 98 and a pair of bent inlet tabs 99. The tabs 99, due to their shape, facilitate entry of an anchorage bar (not shown) into the receiving area 97 when the pin is pushed rearwardly along path 95 by the rod. The angled surfaces formed by bent tabs 99 create a ramp surface on the front edges of the tabs 99 which provides a larger opening to locate the anchorage bar. Then, as the connector is pushed into place onto the anchorage bar, the ramps force the anchorage bar up into the receiving area 97 of the connector, thereby making attachment easier.

FIGS. 5-9 show yet another connector 100, along with a pin 102 and a spring 104. However, as noted immediately in these FIGURES, two receiving areas 105-106 are formed, which makes this design particularly advantageous for applications where either right hand or left hand connections will or could be encountered. The anchorage bar 137 can be locked into either receiving area 105 or 106, and the connector 100 can be used with either receiving area 105 or 106 oriented so as to face the anchorage bar 137.

Connector 100 includes a hole 108 at one end for attachment of the strap length adjuster (as previously described), a slight bend 110 adjacent thereto and a generally planar top stamping 112. Located along both edges of top stamping 112 are bent walls 114. A space between the walls 114 creates a first slot 116 arranged to receive the pin 102, which in this case includes an annular head 120 of a size suitable to be connected to a release button, which can be grasped by the user, or, if no release button is present, suitable to be grasped directly by the user.

A downwardly depending bend 125 extends from stamping area 112 and in a spaced apart relationship to slot 116. The bend 125 includes a hole 128 which is coaxial with slot 116 and is arranged along with the size of pin 102 to allow opposite ends of the pin 102 to extend outwardly respectively of the wall 114 and the bend 125. In the first instance, pin 102 should extend a sufficient distance to allow a release button to engage with a pin 102 to allow a user to slide the pin 120 away from opening 130, while, in the other instance, the pin should be long enough to block the entrance 130 to receiving areas 105-106.

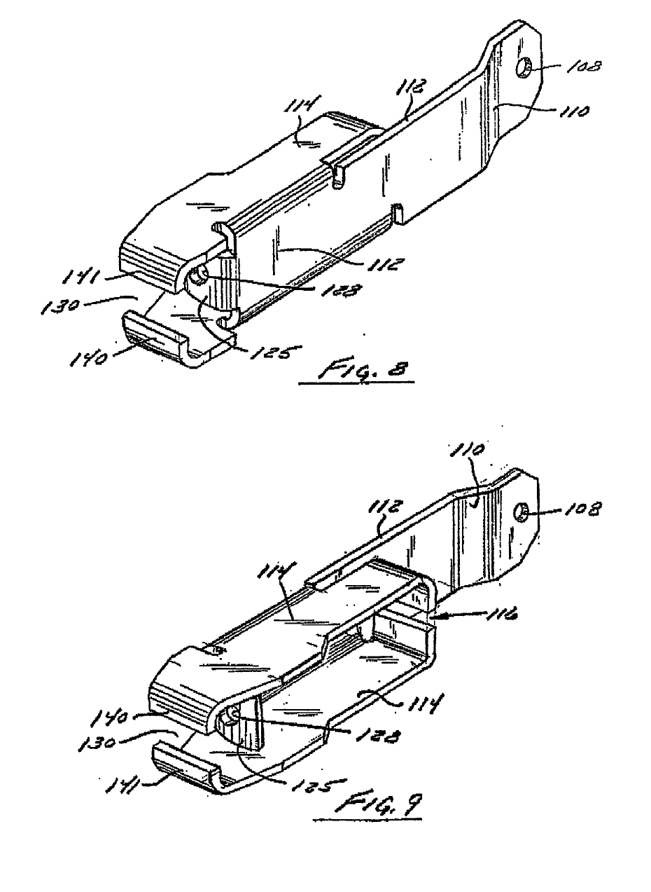

The spring 104 surrounds pin 102 intermediate slot 116 and hole 128, with the left side of the spring 104 held in place by ears 135, seen best in FIG. 6. An anchorage bar 137 is shown in cross-section at 137 in FIG. 6-7. Finally, FIGS. 5-9 show a pair of curved entrance guides 140-141 gently converging toward entrance 130. These curved entrance guides 140-141 allow for rotation of the connector about the anchorage bar both into and out of the page in FIGS. 5-7. This construction allows for attachment of the connector to the anchorage bar at an angle (versus attachment of the connector perpendicular to the anchorage bar). The curved entrance guides 140-141 are also configured to provide a ramp surface to guide the anchorage bar into the appropriate receiving area 105-106.

Now that the main components of connector 100 have been described, its operation can be explained and visualized by reference to the five FIGURES. It should be remembered, however, throughout this description that a housing can be provided about the illustrated parts of the connector 100 (allowing access to entrance 130), and that any of the aforementioned strap length adjuster techniques can be employed with this embodiment, including those in which the strap is attached directly to the connector 100 or the single or double pivot techniques described in connection with FIGS. 2 and 3.

The system of FIG. 5 does not show an anchorage, and so the compression spring 104 is in its “at rest” position, with the pin protruding through entrance 130. When it is desired to attach the connector 100 to an anchorage bar 137, the entrance 130 is positioned adjacent the bar 137 and the connector is urged forwardly causing the pin retraction illustrated in FIG. 6. Note that the user does not touch the pin head 120 to achieve pin retraction; rather, the pin 102 is spring biased inwardly. The part of the system illustrated in FIG. 6 shows bar 137 immediately before it enters a receiving area 105 or 106, but it should now be clear that when this point is reached, and due to the rounded nature of the pin 102 and the entrance guides 140-141, the bar 137 will fall into one of the receiving areas 105-106 causing the pin to immediately snap forwardly (as shown in FIG. 7) to prevent escape of rod 137.

When it is desired or necessary to remove the connector 100 from the rod 137, the user grasps a release button connected to the head 120 of pin 102 and pulls it rearwardly, at least as far as illustrated in FIG. 6, at which point the connector system can be removed simply by pulling the system away from rod 137. This step is also facilitated by the rounded nature of the rod 137 and the smooth curves of the guides 140-141. The pin 102 is released after removal from the anchorage bar 137, and the vehicle seat to which the strap and connector system is attached may be removed, adjusted, etc. When the federally mandated standards are fully implemented, safe and easy coupling of vehicle seats to a variety of vehicles will be assured.

FIG. 10 points out yet another feature of the embodiment shown in FIGS. 5-9, i.e., the ability of the connector system 150 to rotate about 20° to either side due to the construction of the stamping of connector 100 and the curve of the bend 125. Combined with one of the above-described strap length adjuster systems, the resultant additional flexibility insures proper alignment between connector 100 and the strap. Strap wear is increased and strength properties are correctly distributed across the width of the strap.

As recognizable from the description above, an advantage of the present invention is that a spring-loaded pin connector can be provided which allows for the remote coupling and un-coupling of a connector portion about an anchorage. Another advantage of the present invention is that a connector can be provided which is easy to operate and which may be used with package shelf or lower seat anchorages. Yet another advantage of the present invention is that a system can be provided for connecting a spring-loaded pin connector to a tether strap and to an anchorage and which permits rotation of the strap with respect to the connector in at least one plane. A still further advantage of the present invention is that a system can be provided for connecting a spring-loaded pin connector to an anchorage and which permits rotation of the connector with respect to a tether strap in two perpendicular planes.

While the present invention has been described in connection with several embodiments and several combinations with strap length adjustment components, the present invention is not to be limited to the specifically illustrated embodiments and/or combinations or to any specifically mentioned embodiments and/or combinations which are not illustrated. Rather, the invention is to be limited solely by the scope of the claims which follow.

What is claimed is:

1. A connector for coupling a strap to an anchorage comprising:
a body having a strap coupling location and a receiving area spaced apart therefrom;
a closure element movable from a first position in which access to the receiving area is blocked to a second position in which access to the receiving area is allowed, the closure element being biased to the first position.

2. The connector of claim 1 wherein the strap coupling location includes a slot for attachment of a strap.

3. The connector of claim 2 further including a strap length adjuster.

4. The connector of claim 3 wherein the strap length adjuster is rotatably connected to the body.

5. The connector of claim 4 wherein the coupling location is a plate having a hole therein and the strap length adjuster includes a coupling location arranged to be rotatably coupled to the plate.

6. The connector of claim 5 wherein the plate and the adjuster are rotatably coupled by a rivet passing through the hole.

7. The connector of claim 3 wherein the strap length adjuster includes two sections coupled together by a pivot section, whereby a strap coupled to it is capable of rotation about two perpendicular axes.

8. The connector of claim 1 wherein the closure element is a pin.

9. The connector of claim 1 wherein the receiving area is generally U-shaped having an opening, the closure element blocking at least a portion of the opening when in its first position

10. The connector of claim 9 wherein the closure element is a pin.

11. The connector of claim 1 wherein the closure element is biased to the first position by a spring.

12. The connector of claim 11 wherein the closure element is a pin and the spring surrounds the pin.

13. The connector of claim 12 wherein the spring is a compression spring.

14. The connector of claim 12 wherein the spring is an extension spring.

15. The connector of claim 1 wherein the closure element includes a grasping portion to move the closure element from its first to its second position.

16. The connector of claim 15 wherein the closure element is an L-shaped pin and the grasping portion is a leg of the L-shaped pin.

17. The connector of claim 15 wherein the closure element is a pin having an enlarged head, the enlarged head being the grasping portion.

18. The connector of claim 1 further including a casing for the body, the casing having an opening to permit access to the receiving area.

19. The connector of claim 1 further comprising a second receiving area, the second receiving area being separated from the receiving area when the closure element is in its first position.

20. The connector of claim 1 wherein the body includes guides for directing an anchorage toward the receiving area.

21. A system for coupling a child's vehicle seat to an anchorage fixed to a vehicle, the anchorage comprising a bar, the system including:
at least one strap having an end; and
a connector attached to the strap end and including a body having a receiving area sized to receive the bar and a closure element for being selectively moved to a position permitting the bar to enter or be removed from the receiving area.

22. The system of claim 21 wherein the closure element is a spring-loaded pin movable between a first position in which entry or removal of the bar is prevented and a second position in which entry or removal of the bar is permitted.

23. The system of claim 22 wherein the spring surrounds the pin and the pin includes a grasping portion.

24. The system of claim 23 wherein the grasping portion is a bent portion of the pin spaced apart from the receiving area.

25. The system of claim 23 wherein the grasping portion is an enlarged portion of the pin spaced apart from the receiving area.

26. The system of claim 22 wherein the body includes a second receiving area separated from the receiving area when the pin is in its first position.

27. The system of claim 21 further including a strap length adjuster.

28. The system of claim 27 wherein the strap length adjuster is rotatably coupled to the connector body for rotation about a first axis.

29. The system of claim 28 wherein the strap length adjuster includes components pivotable about a second axis perpendicular to the first axis.

30. The system of claim 21 further comprising an enclosure for the body, the enclosure including a mouth for permitting entry and removal of the bar.

31. The system of claim 30 wherein guides are provided for directing the bar into the mouth and toward the receiving area.

32. The system of claim 30 wherein the guides are bent portions of the body providing converging ramps.

33. A method for securing a child vehicle seat to a vehicle anchorage bar comprising the steps of:
providing a connector having a vehicle seat strap coupled thereto, the connector having a receiving area and a closure element, the receiving area being sized to receive the anchorage therein, and the closure element being selectively movable between a first position which blocks entry to or removal of the anchorage from the receiving area and a second position in which entry to or removal of the anchorage from the receiving area is permitted;
moving the closure element to its second position;
placing the anchorage in the receiving area; and
moving the closure element to its first position.

34. The method of claim 33 wherein the closure element is a spring loaded pin having an end biased to the first position, and the placing step comprises urging the anchorage against the end of the pin until the anchorage enters the receiving area, and the step of moving the closure element to its first position is automatically carried out by the spring once the anchorage moves into the receiving area.

35. The method of claim 32 comprising the additional steps of removing the connector from the anchorage by moving the closure element to its second position against a spring force and thereafter removing the anchorage from the receiving area.
